(19) United States
(12) Patent Application Publication
(10) Pub. No.: US 2003/0008637 A1
(43) Pub. Date: Jan. 9, 2003

(54) System and method for implementing secure mobile-based transactions in a telecommunication system

(76) Inventor: Harri Vatanen, Surrey (GB)

Correspondence Address: LANCE J. LIEBERMAN, ESQ., COHEN, PONTANI, LIEBERMAN & PAVANE, 551 FIFTH AVENUE, SUITE 1210, NEW YORK, NY, 10176, US

(21) Appl. No.: 09/950,347

(22) Filed: Sep. 10, 2001

(30) Foreign Application Priority Data
Mar. 8, 1999 (FI) 990502
Mar. 7, 2000 PCT/FI00/00176

(51) Int. Cl. H04M 1/66

(52) U.S. Cl. 455/410; 455/411; 455/412

(57) ABSTRACT

A system for implementing secure transactions includes a mobile communication network, a service provider communicating with the mobile communication network and a mobile station communicating with the mobile network and, through the network, with the service provider. A subscriber identity module, in which an executable service application is stored, is associated with the mobile station. The system further includes means for transferring the material needed in implementing the transaction into the mobile station, means in the mobile station for presenting the transferred material to the user, means for requesting the user's acceptance of the presented material for digital signing, means for activating a PIN inquiry if the user accepts the material, means for checking, in the subscriber identity module, the correctness of the PIN code entered by the user, and means for encrypting and/or digitally signing the transmitted material using the service application stored in the subscriber identity module if the PIN code entered by the user is correct.

### BACKGROUND OF THE INVENTION

1. Field of the Invention

The present invention relates to telecommunication systems. In particular, the invention is directed to an advanced method and system that permits the receiver of a service to safely, securely and flexibly accept the material needed in or to effect a transaction with the service using the receiver's mobile telecommunication station.

2. Description of the Related Art

It is a currently known practice to utilize a digital mobile station in a communication system, such as a GSM (Global System for Mobile communications) system, for effecting by electronic means a commercial transaction such as the payment of a bill or the remitting of a payment. U.S. Pat. No. 5,221,838, for example, discloses a device that can be employed for making such a payment. Specifically, the patent describes an electronic payment system in which a terminal capable of wireless and/or wired data transfer is used as a payment terminal. The terminal is described in the patent as a card reader, a keyboard, a bar code reader for data input and a display for presentation of payment information.

Other prior art, such as patent specification WO 94/11849, discloses a method for utilization of telecommunication services to carry out payment transfers via a mobile telephone system. The described system includes a terminal that communicates over a telecommunication network with a service provider's mainframe computer in which the payment system of the service provider is implemented. A terminal in the mobile telephone network, i.e. a mobile station, is provided with a subscriber identity unit that stores information required for subscriber identification and for encryption of telecommunication traffic; that information can be read into the terminal for use in the mobile station. The patent mentions, by way of example, the GSM system in which an associated SIM (Subscriber Identity Module) card is commonly used as a subscriber identity unit.

In the system described in patent specification WO 94/11849, the mobile station communicates with a base transceiver station of the mobile communication network. A connection is set up from the base transceiver station to a payment system and the amount to be paid and data required for subscriber identification are transmitted to the payment system. In the banking service which is described in that specification, the client inserts a bank service card containing a SIM unit into a GSM network terminal, and the terminal in the telephone-based banking service may be a standard GSM mobile station. Through that arrangement and the method therein described a wireless telecommunication connection can be employed for remitting payments and/or paying bills or implementing other like banking services.

One problem in these prior-art implementations is that they do not sufficiently monitor or assure the reliability of a payment transaction carried out by means of a mobile station. It is important that a mobile station application, by way of which a payment transaction is effected, verify the user's authenticity separately for each transaction. When a mobile station is used for remitting a payment, it is essential that both the payer and the payee can rely on the system. The payer must know with certainty and precision the item or service for which h or she e is paying, the amount being paid, the particular payee being paid, and so on. The receiver of the payment, on the other hand, needs to know with certainty that the payer has expressed his or her clear intention to remit the payment.

Digital signing (i.e. using a digital signature), which is today considered a general requirement in implementing electronic payment, is used for verification of the integrity of the information or material transmitted and the authenticity of the sender. A digital signature is generated by encrypting a hash code computed from the material to be transmitted, using the sender's secret key. Since nobody else knows the sender's secret key, when decrypting the information using the sender's public key the receiver can ascertain with certainty that the material is unchanged from its intended form and that it has been generated by that sender. One example of an algorithm used in digital signing is the RSA encryption algorithm, which provides a public-private key encryption system and is also used for the encryption of messages.

### OBJECTS AND SUMMARY OF THE INVENTION

It is accordingly the desideratum of the present invention to eliminate, or at least significantly alleviate, the problems and deficiencies present in prior art systems and methods, including by way of example those described hereinabove.

It is a particular object of the invention to provide a new type of method and system for user acceptance, separately for each transaction, of material needed in that transaction.

It is a further object of the invention to provide a relatively simplified method, that can be implemented using current technology, for implementing commercial transactions such as the paying of bills and other banking transactions by means of a mobile station.

In the context of this disclosure, the term “material” is intended to refer to and include any of a virtually unlimited multiplicity of types of electronically interpretable and/or exchangeable messages, notices and/or data structures of various contents. Such material may also, by way of illustrative example, include or consist of object type or software object type information which is processable in an electronic form.

The present invention broadly provides, in one aspect, a method for implementing a secure transaction by means of a mobile station which includes a subscriber identity module and an executable service application stored in the subscriber identity module. The mobile station communicates with a service provider via a mobile communication network.

The mobile communication network may for example be a GSM network. In accordance with the invention, the material essential to or otherwise needed in or to complete the transaction is transferred into the mobile station and is presented to the user by means of the mobile station. The user is then asked to give his or her approval for digital signing of the material; if the user thus indicates his or her approval, a PIN (Personal Identification Number) inquiry is activated in the mobile station, the PIN code entered by the user is checked for correctness in the subscriber identity module and, if the entered PIN code is determined to be correct, the material is encrypted and/or signed using the service application stored in the subscriber identity module. In various implementations of the invention, the user may indicate approval or acceptance of the presented material or transaction through immediate entry of the user's PIN code, or the user may enter the PIN code in response to the PIN inquiry or other express request on the mobile station for user entry of the required PIN code.

In one implementation of the inventive method, if the user of the mobile station does not approve or accept for signature the material needed in the transaction, or if the user PIN entered in three successive attempts is determined to be incorrect, then a rejection message is sent to the service provider that generated the material. The material can be generated using a pre-agreed or predetermined form overly in which the essential information is filled in before being transferred to the mobile station, or the essential information generated by the service provider and transmitted to the mobile station may be entered into the predetermined form that is stored on the subscriber identification module for presentation to the user, or using any other mutually agreed and known data structure.

Thus, in the above-described method the client is presented with the opportunity to accept the material presented on the display of the mobile station and, after the material has been accepted, it is sent to the service provider, such as a bank. The client or mobile station user may also communicate locally with an automatic payment machine or the like, in which case the payment machine transmits to the client the material intended to be accepted. The client then exchanges messages locally with the payment machine and the payment machine further transmits the digital signature information. This local communication can be carried out without necessarily using or involving a mobile communication network.

Based on the payment traffic that it is handling, such a payment machine can infer that the client has accepted the service and payment form presented. Thus, the payment machine can locally serve the client in the manner desired and approved by the user-client, without necessarily expecting the bank's approval for it. In practice, such a procedure corresponds to the common practice in which a client pays for products or services using the client's bank card, as for example at a cash desk in a store which provides the products or services to the client without contacting the bank to verify the authenticity of the payment.

The material may also be encrypted before being transferred into the mobile station, in which case the material must be correspondingly decrypted at the mobile station before being digitally signed. In this manner it is possible to assure that only the intended mobile station will understandably receive the transmitted material, and thereby guarantee security of the subject information.

In implementing the inventive method, the mobile station may be required to be started or initialized in signature mode before any material is transferred into the mobile station. In practice, this may mean that the user must enter, when powering up the mobile station, another (or the same) predetermined PIN code with which the mobile station has been configured to start in a predetermined signature mode. In this way a form of local authentication is additionally provided.

The present invention also provides a system for implementing a secure transaction using a mobile station. The system includes a mobile communication network, a service provider in communication with the mobile communication network, and a mobile station in communication with the mobile communication network and, by way of the network, with the service provider. The mobile station includes an associated subscriber identity module and a service application stored in the subscriber identity module. The system additionally includes means for transferring the material needed in the transaction into the mobile station; this transferring means may for example be implemented in the mobile communication network and in the mobile station using a short message service or a local link, such as an infrared or Bluetooth link. A detailed description of well-known Bluetooth technology can for example be found at the website www.bluetooth.com. The mobile station further includes means, such as a visual display, for presenting the transferred material to the user.

In accordance with the invention, the system also includes means for requesting the user's acceptance of the presented material, means for activating a PIN inquiry if the user accepts the presented material, means for verifying in the subscriber identity module the PIN code that has been entered or supplied by the user, and means for encrypting and/or digitally signing the material using the service application stored in the subscriber identity module if the PIN code supplied by the user has been determined to be correct.

The inventive system may further include means for sending a rejection message to the service provider that generated the material if the user of the mobile station does not accept for signature the material needed in the transaction or if the PIN code input to the mobile station by the user is determined to be incorrect.

As compared with prior art systems and methods, the present invention advantageously renders it easier to implement payment applications and verification operations and the like using a mobile station while at the same time providing a notably higher level of security for the user. The invention accommodates reliable use of a mobile station for accepting the material needed in a transaction and for signing it digitally, thus allowing acceptance and digital signing operations to be applied to and utilized in conjunction with many different applications.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a block diagram of currently preferred system in accordance with the present invention;

FIG. 2 is a block diagram of a method implementing the present invention; and

FIG. 3 is a flow chart of a currently preferred embodiment of the inventive method.

### DETAILED DESCRIPTION OF THE CURRENTLY PREFERRED EMBODIMENTS

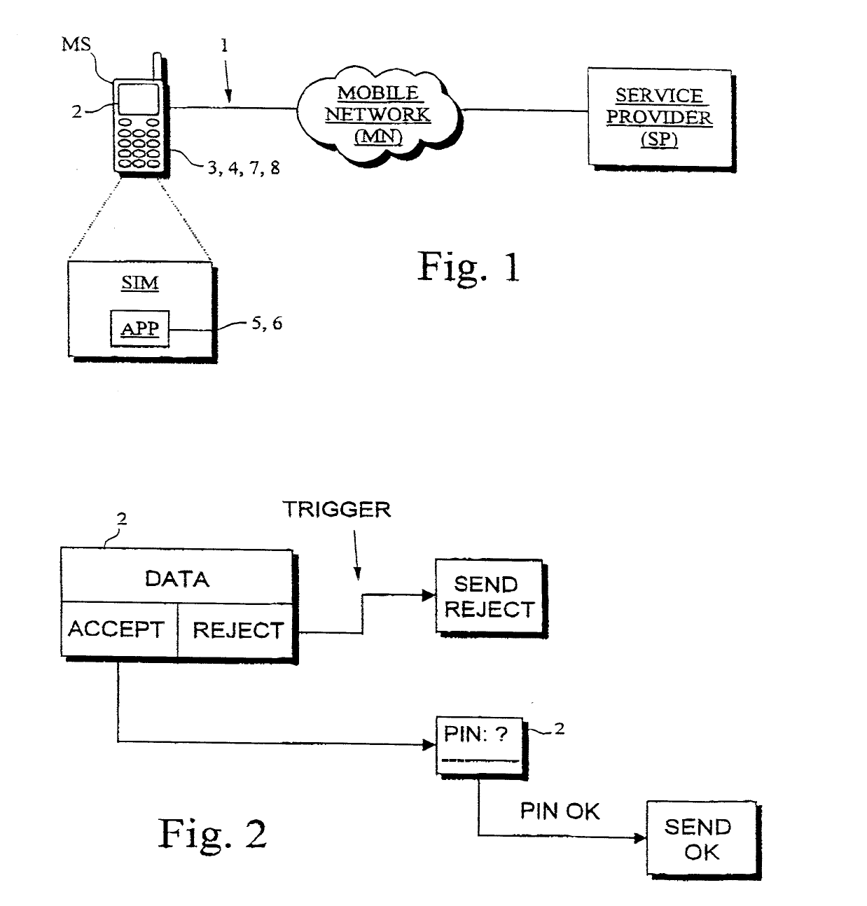

The system presented by way of currently-preferred and illustrative example in FIG. 1 includes a mobile communication network MN, a mobile station MS connected to the network MN and a service provider SP also connected to or otherwise in communication with the mobile network MN. The mobile communication network may for example be a GSM network, and the service provider may be a store, a bank, a parking facility, a ticket office, or any like or other service provider. In practice, the service provider is connected to the mobile communication network MN via a terminal or a server that resembles or implements a mobile station, or via a combination thereof; such implementations, and others that may be utilized for providing a link from a service provider to a mobile communication network, are well known and their selection and use will be apparent to those of ordinary skill in the art and will not, therefore, be further described herein.

The mobile station includes an integral or associated subscriber identity module SIM, an executable service application APP—operable for implementing a transaction at the mobile station end in cooperation with the service provider—which is stored in the subscribe identity module, and a display 2 for visually (by way of example) presenting the material (which has been received into the mobile station) to the user. Also stored in the service application are the encryption and decryption keys required to effect or complete a transaction. The service application may also include or store information relating to or including other parameters and/or data structures that are used in the service.

The mobile station depicted in FIG. 1 further includes means 3 for requesting the user's acceptance of the presented material, means 4 for activating a PIN inquiry if the user accepts the presented material, means 5 for checking, in the subscriber identity module, the correctness of the PIN code entered or supplied by the user, and means 6 for encrypting and/or digitally signing the received material, using the service application stored in the subscriber identity module, if the PIN code supplied by the user is determined to be correct. The various means 3, 4, 5 and 6 may be implemented in one or more suitable components in the mobile station or in the subscriber identity module or in a combination thereof. In the system shown in FIG. 1, the PIN code is checked for correctness in the subscriber identity module using means 5, and the material is encrypted and/or digitally signed in the subscriber identity module using means 6.

The inventive system may additionally implement the optional function of sending a rejection message to the service provider that generated the material if the user of the mobile station does not accept or consent to sign the material needed to effect or complete the transaction. The system depicted in FIG. 1 includes an optional means 8 for sending a rejection message to the service provider that generated the material if the PIN code entered by the user into the mobile station is determined to be incorrect. This rejection message may for example be sent when incorrect PIN entries are to be recorded in the system, and may by way of illustration be implemented by sending the rejection message to the service provider after the user has repeatedly entered an incorrect PIN code, such as three consecutive times. The service provider can then initiate appropriate measures to establish the authenticity of the user of the mobile station.

An embodiment of the inventive method is presented in block diagram form in FIG. 2. As there shown, the material DATA to be signed has been presented on the display of the mobile station 2, giving the user an opportunity to either accept or reject it. When the user presses the “Accept” button to indicate acceptance of the presented material DATA, the user's choice triggers the next action in the procedure; specifically, the text “PIN:?” appears on the display, thus asking the user to enter a transaction-specific PIN code. After the user has keyed in or otherwise entered a correct PIN code, the service application APP (FIG. 1) performs the required operations on the material and sends it to the service provider SP together with an acceptance message. If on the other hand the user rejects the data, then a rejection message is sent to the service provider.

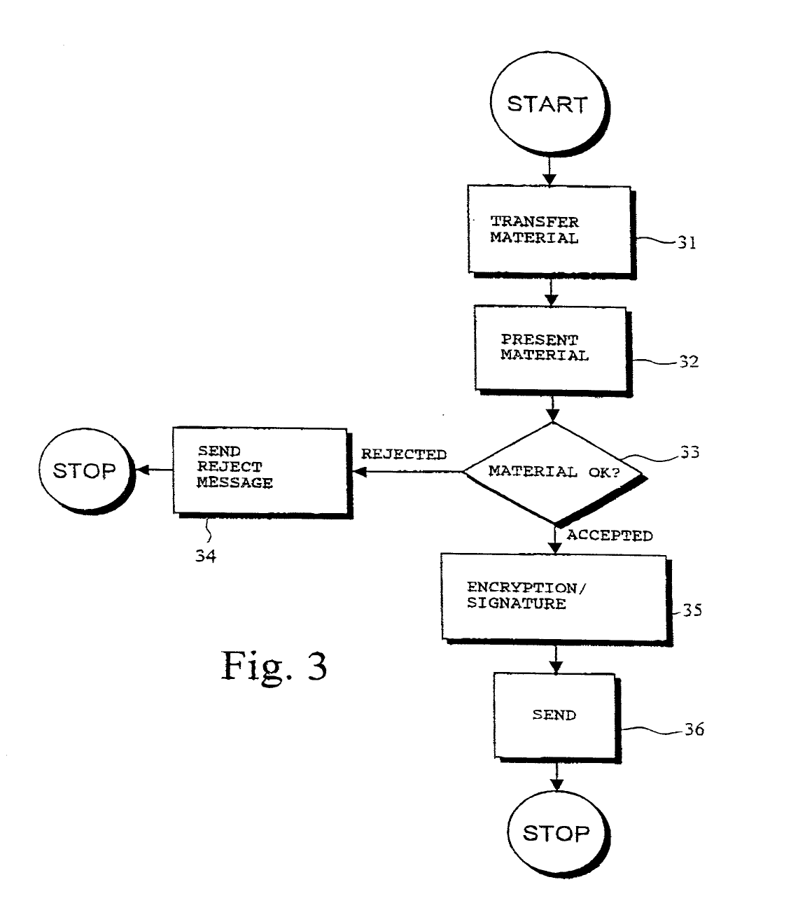

FIG. 3 presents a flow chart of a preferred embodiment of the inventive method. The material is first transferred into the mobile station (block 31), as from the surface provider. At the mobile station, the material is presented to the user (block 21), in this implementation on the display 2 of the mobile station. At the same time, the user is asked (block 33) to either accept or reject the presented material. If the user accepts the material, then the method proceeds to block 35, at which the required actions for encrypting and/or digitally signing of the material are performed. After the actions at block 35, the accepted material together with an acceptance message is sent (block 36) to the service provider. If on the other hand the user, at block 33, rejects the material, then the method proceeds to block 34 at which a rejection messages is sent to the service provider.

The present invention thus significantly facilitates the operations that are carried out by a mobile station user in conjunction with a transaction effected by way of a mobile station. The invention notably improves the security of transactions carried out using a mobile station. In practice, the encryption and digital signing procedures necessary to or utilized in the inventive method are based on an executable application which is stored in the subscriber identity module and/or in the mobile station, such as in a digital signal processor, and which performs the required operations on the material after the user has affirmatively indicated his or her acceptance The material can be transmitted into the mobile station on the basis or initiation of an order placed, by way of example, by telephone or over the Internet, in which case the user's acceptance of the displayed or presented material functions as an acknowledgement to the service provider with whom the order was placed. Acceptance of the presented material may constitute an acknowledgement and approval of an order, an offer, a parking charge, or any relevant service that involves a transaction.

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for implementing a secure transaction between a mobile station of a user and a service provider through a mobile communication network, wherein the mobile station has an associated subscriber identity module in which a service application is stored, comprising the steps of:
transferring material needed in the transaction with the service provider from a sender into the mobile station;
presenting the transferred material to the user on the mobile station;
requesting user acceptance of the presented material;
activating a PIN inquiry in the mobile station in response to user acceptance of the presented material;
checking for correctness, in the subscriber identity module, a PIN code entered at the mobile station by the user; and
where the entered PIN code is determined to be correct in said checking step, one of digitally signing the transmitted material using a private key of the user and encrypting the transmitted material using a public key of the sender using the service application stored in the subscriber identity module.

2. A method in accordance with claim 1, further comprising the step of sending from the mobile station to the service provider, if the user does not accept the presented material, a rejection message.

3. A method in accordance with claim 1, further comprising the step of sending from the mobile station to the service provider, if the entered PIN code is determined ins aid checking step to not be correct, a rejection message.

4. A method in accordance with claim 1, wherein said transferring step comprises:
entering, into a predetermined form overlay having an identifier, information essential to the transaction to thereby define the material for transfer to the mobile station; and
transferring the material defined by the entered essential information from the sender into the mobile station.

5. A method in accordance with claim 1, further comprising the step of powering up the mobile station in a signature mode that requires that the user enter a valid power-up PIN for use of the mobile station in receiving and presenting transferred material.

6. A method in accordance with claim 1, wherein said one of signing and encrypting of the transmitted material is effected using a public-private key system.

7. A system for implementing a secure transaction using a mobile station that is connected to a mobile communication network for communication through the mobile network with a service provider in communication with the mobile network, said system comprising:
a subscriber identity module associated with the mobile station;
a service application stored in the subscriber identity module;
means for transferring, into the mobile station, material needed in the transaction with the service provider;
means in the mobile station for presenting the transferred material to a user of the mobile station;
means for requesting user acceptance of the presented material;
means for activating a PIN inquiry in response to a user acceptance of the presented material;
means for checking for correctness, in the subscriber identity module, a PIN code entered at the mobile station by the user; and
means for one of, where the entered PIN code is determined to be correct by said means for checking, digitally signing the transmitted material and encrypting the transmitted material using the service application stored in the subscriber identity module.

8. A system in accordance with claim 7, further comprising means for sending from the mobile station to the service provider, if the user does not accept the presented material, a rejection message.

9. A system in accordance with claim 7, further comprising means for sending from the mobile station to the service provider, if the entered PIN code is determined by said checking means to not be correct, a rejection message.

10. A system in accordance with claim 7, wherein the material for presentation to the user is defined by a predetermined form overlay that is provided with an identifier and is stored in the subscriber identity module, and information essential to the transaction that has been entered into the form overlay for presentation to the user.

11. A mobile station for implementing a secure transaction between the mobile station and a service provider via a mobile communication network, said mobile station comprising:
a subscriber identity module;
a service application stored in the subscriber identity module;
means for receiving into the mobile station material needed in the transaction with the service provider;
means for presenting the received material to the user on the mobile station;
means for requesting user acceptance of the presented material;
means for activating a PIN inquiry in the mobile station in response to a user acceptance of the presented material;
means for checking for correctness, in the subscriber identity module, a PIN code entered at the mobile station by the user; and
means for one of, where the entered PIN code is determined to be correct by said means for checking, digitally signing the transmitted material and encrypting the transmitted material using the service application stored in the subscriber identity module.

12. A mobile station in accordance with claim 11, further comprising means for sending from the mobile station to the service provider, if the user does not accept the presented material, a rejection message.

13. A mobile station in accordance with claim 11, further comprising means for sending from the mobile station to the service provider, if the entered PIN code is determined by said checking means to not be correct, a rejection message.
